(19) United States
(12) Patent Application Publication
(10) Pub. No.: US 2012/0007704 A1
(43) Pub. Date: Jan. 12, 2012

(54) Periodic correlated magnetic actuator systems and methods of use thereof

(76) Inventor: Michael S. Nerl, Saint Louis, MO (US)

(21) Appl. No.: 13/178,816

(22) Filed: Jul. 8, 2011

Related U.S. Application Data
(60) Provisional application No. 61/362,585, filed on Jul. 8, 2010.

(51) Int. Cl. H01F 7/02

(52) U.S. Cl. 335/219

(57) ABSTRACT

The present invention comprises correlated magnet actuators, devices incorporating said actuators, and methods of use thereof. The actuators utilize magnetic drives comprising a pair of complimentary correlated permanent magnet pairs, arranged in a separable and opposing fashion. The attractive or repulsive force of each correlated magnet pair drops significantly after only a few degrees of rotation off of a prime attractive or repulsive rotational alignment, allowing the magnets to be binarily manipulated between a correlated and decorrelated alignment. The linear motion resulting from the periodic coupling and decoupling of the magnetic pair can be translated to supporting conveyance structures to produce rotary (torque) output work. This output work can be harnessed to drive secondary utilization components such as a generator or a pump, or other devices dependent on rotary work output for their operation.

### CROSS REFERENCE TO RELATED APPLICATIONS

This application claims the benefit of U.S. Provisional Patent Application No. 61/362,585 filed Jul. 8, 2010.

### FIELD OF THE INVENTION

The present invention is directed to electromagnetic motors. Specifically, the present invention is directed to permanent magnetic actuators and methods of use thereof. More specifically the present invention is directed to the binary spatial manipulation of correlated magnetic drives to translate permanent magnetic force into useful rotary work output.

### BACKGROUND OF THE INVENTION

Electromagnetic motors are found in applications as diverse as industrial fans, blowers and pumps, machine tools, household appliances, power tools, and disk drives. Most electromagnetic motors produce rotary (torque) work by converting electrical energy into mechanical energy (torque). Existing electromagnetic motors operate on the principle that a conductor carrying a current in a magnetic field tends to move perpendicularly to that field; the electromagnetic torque developed by an armature or rotating portion of the motor being proportional to the magnetic flux in the stationary field and to the armature current. However, the use of permanent magnetic energy stored in the fields of permanent magnets to produce mechanical energy has been elusive. The utilization of permanent magnetic energy is limited in that the work required to separate (negative system work burden) a previously attracted pair of magnets would always be greater than the work produced (positive system work) during the original dynamic attraction of a magnet pair. The net difference between the negative work required and positive work produced results in a net negative value and therefore rendered such topologies irrelevant due to inability to produce positive net work output. Accordingly, there is a need in the art for devices and systems that can harness permanent magnetic energy to produce a net positive work value in order to generate useful mechanical work.

### SUMMARY OF INVENTION

The present invention is directed to actuators that comprise correlated magnetic drives, devices that incorporate said actuators and methods of use thereof. The actuator's correlated magnetic drives contain a pair of complimentary correlated magnet pairs arranged in a separable and opposing orientation. The correlated magnets each contain a complimentary pattern of multiple magnetic field sources encoded on a substrate. The pattern, or code, defines one or more prime attraction (correlation) and repulsion (decorrelation) magnetic states between a pair of complimentary correlated magnet pairs. In contrast to conventional permanent magnets, the torque required to decorrelate a fully attracted correlated magnet pair is significantly lower than the magnetic force needed to separate a fully attracted conventional magnet pair. The actuators of the present invention utilize rotary motion to manipulate the orientation of the correlated magnet pair between these attraction and repulsion states to induce linear motion of the magnetic drive. This linear motion may be translated into rotary work output by connecting the magnetic drive or drives to conveyance structures in a variety of topological arrangements. The rotary work output can in turn be utilized by a secondary utilization device such as a pump or generator, or any other device dependent on rotary work for its operation.

In one exemplary embodiment, the correlated magnetic drives comprise a complimentary magnet tier-pair. Each tier may comprise a single correlated magnet or a series of correlated magnets. The correlated magnets may be monolithic or a multi-geometric variant thereof. Geometric variants may include, but are not limited to, stratified or laminated variants. In one exemplary embodiment, the magnets are neodymium magnets. Each tier may be housed in a separate housing or retainer structure allowing for each tier to be separately connected to any supporting conveyance structures. In one exemplary embodiment, a first tier is statically connected to a conveyance structure while the second tier is dynamically connected to the conveyance structure so as to allow rotation of the correlated magnet. In another exemplary embodiment, both tiers are dynamically connected to a conveyance structure to allow rotation of both correlated magnets. In yet another exemplary embodiment, both tiers are statically connected to a conveyance structure, wherein the conveyance structure provides the necessary rotational movement needed to correlate and decorrelate the correlated magnet pairs. The retaining structure may further comprise a rotary flange to facilitate rotary movement between the tier and a connected conveyance structure. In one exemplary embodiment, the retaining structure may further comprise a nesting spline shaft segment for coupling with a work input driver or a work output conveyance component. In one exemplary embodiment, each magnet in the tier pair may have a thin dielectric film coating applied to a top and bottom of the surface of the magnet to prevent direct intra and inter magnet contact. In another exemplary embodiment, a removable adhesive gasket may be applied to the working surface of one or both correlated magnets of the magnet tier pair. In yet another exemplary embodiment, the retaining structure may contain external threads for mating with a compression ring.

In one exemplary embodiment, the coding of the correlated magnets is configured so that binary spatial manipulation produces a strong, or peak, mutual coupling force in only one spatial orientation. In another exemplary embodiment, the coding of the correlated magnet is configured so that binary spatial manipulation produces a strong, or peak, mutual coupling force in more than one spatial orientation. In yet another exemplary embodiment, the correlated actuation magnet coding of a tier is further configured so that the binary spatial manipulation force required to couple and decouple the strong, or peak, mutual force is minimized. In another exemplary embodiment, the correlated actuation magnet coding is configured so that the binary spatial manipulation minimizes the distance required, and therefore the time required, to actuate, translate, couple, and decouple the strong, or peak, mutual force of a tier.

The conveyance structures of the present invention may comprise a fixed frame component, a variable frame component, and a common output shaft. The fixed frame components may include a set of horizontal and vertical members defining an actuator support structure. The fixed frame components may further comprise a pair of fixed connecting rods extending internally over a length of the fixed frame component. The variable frame component may comprise a set of horizontal or vertical members and a mechanism for connecting the variable frame component to the fixed frame component. In one exemplary embodiment, the horizontal or vertical variable frame component members are connected to a pair of saddle shafts moveably connected to the connecting rods of the fixed frame component. The common output shaft may be connected to the variable frame component. In certain exemplary embodiments, the variable frame components are considered part of the common output shaft. In one exemplary embodiment, the first tier of a correlated magnet drive is attached to a fixed frame component and the second tier is connected to a variable frame component. In another exemplary embodiment, the first tier and second tier of the correlated magnet drive are attached to variable frame components. In yet another exemplary embodiment, the first tier and second tier of the correlated magnetic drive are attached to fixed frame components.

The actuators of the present invention may further comprise one or more decorrelation drives. A decorrelation drive functions to decorrelate a correlated magnetic pair. The decorrelation drive may be an electrical, pneumatic, hydraulic, or kinetic driver, or combination thereof. In one exemplary embodiment the decorrelation drive comprises a solenoid. In one exemplary embodiment, the decorrelation drive functions to translate linear force into rotational movement. In another exemplary embodiment, the decorrelation drive comprises an incline plane translator. An inclined plane translator (IPT) may comprise a variable gear component and a static gear component. When the two gears are translated together the IPT translates the initial linear force into subsequent rotational force (torque). In one exemplary embodiment, the variable gear of a IPT is connected to a tier of a magnet drive, and the static gear is connected to a fixed frame component.

The actuators of the present invention may further comprise a drive management system. The drive management system functions to lock one or both tiers, and in certain embodiments the decorrelation drive, from rotating the tiers between their coupled and uncoupled orientations allowing for the controlled initiation and stop of correlated magnetic drive function. Any suitable mechanism for controlling start and stop rotary functions may be utilized. In one exemplary embodiment, the drive management system comprises a start/stop mechanism and a return spring.

The actuators of the present invention may further comprise an initial actuation drive and optionally one or more continuing actuation drivers. An initial actuation drive commences passive system rotation of the actuator system and is utilized to commence the binary manipulation of a correlated magnetic drive or drives. The continuing actuation driver supplies work utilized to continue timed motion and relative orientation of the actuator systems dynamic components and correlated magnet tiers. The initial and continuing actuation drivers may be an electrical, pneumatic, hydraulic, or kinetic driver, or combination thereof.

The actuator systems of the present invention may further utilize a kinetic energy storage (KES) flywheel, or buffer system, to provide utilization load isolation between the actuators and any secondary utilization devices. A KES buffer system may comprise a KES flywheel and set of transmission gears, transition flywheels and clutches attached to a common output shaft and configured to control transfer and isolation of rotational force between an initial actuation driver, two or more actuators, the KES flywheel, and a secondary utilization device. In one exemplary embodiment, the KES buffer system is used in conjunction with a kinetic variant initial actuation driver. In another exemplary embodiment, a levitating axial magnetic bearing mechanism may be further coupled to the KES flywheel. In one exemplary embodiment, the levitating axial magnetic bearing mechanism is a Halbach array. In another exemplary embodiment, the actuator system further comprises a permanent magnet alternator coupled to the common output shaft. In yet another exemplary embodiment the actuator system is further enclosed in a Faraday cage.

The actuators of the present invention may be arranged in a number of different topologies. A single correlated magnetic drive and accompanying conveyance structures define a single tier actuator. Single tier actuators may be joined together to form multi-tier actuators. Multi-tier actuators may be arranged in series or parallel to form multi-tier actuator arrays. Multiple actuators may also be arranged in a number of additional topologies such as, but not limited to, V-drive, radial, linear, opposing piston, W-drive and X-drive. In another aspect, the present invention is directed to devices incorporating the actuators of the present invention.

### BRIEF DESCRIPTION OF THE DRAWINGS

The present invention is described with reference to the accompanying drawings. In the drawings like reference numbers indicate like, but not necessarily identical, elements. Additionally, the left-most digit(s) of a reference number identifies the drawing in which the reference number first appears.

FIG. 1 depicts an exemplary correlated magnet coding pattern.

FIG. 2 is a schematic depicting how variant correlated magnet tier topologies that may be utilized to vary the magnetic force per correlated magnetic drive.

FIG. 3 is a schematic depicting the four discrete and periodic operating modes of an exemplary correlated magnetic drive of the present invention.

FIG. 4 is a schematic demonstrating the relationship between attractive force and linear movement over the course of an exemplary correlated magnetic drives operating modes.

FIG. 5 is a diagram identifying the key magnetic field effect zones defined between two correlated magnets of a correlated magnet drive of the present invention.

FIG. 6 is a schematic depicting an exemplary incline plane translator.

FIG. 7 is a schematic depicting an exemplary single tier actuator of the present invention.

FIG. 8a-c are a series of schematics depicting an exemplary correlated magnetic drive. FIG. 8a provides a general overview of the exemplary correlated magnetic drive. FIG. 8b depicts the use of external threads on the tier housing to allow mating with a compression ring. FIG. 8c depicts the exemplary positioning of dielectric thin film layer betweens multiple magnets of a single tier.

FIG. 9a-c are a series of schematics depicting the various components of an exemplary decorrelation drive. FIG. 9a provides the primary components of the exemplary decorrelation drive. FIG. 9b indicates the positioning of a lower guide key on the variable gear of an IPT. FIG. 9c provides a more detailed view of an exemplary recorrelation delay mechanism of the decorrelation drive.

FIG. 10 provides a diagram outlining the action states defining an IPT variable gear's interaction with the recorrelation delay mechanism.

FIG. 11a-c are a series of schematics of the components an exemplary drive management system. FIG. 11a provides an overview of the primary components of the drive management systems and their position in relation to a first tier of a correlated magnet drive and the decorrelation drive. FIG. 11b and 11c comprise alternate views providing a more detailed view of the various components of an exemplary decorrelation start-stop system of the drive management system.

FIG. 12 is a schematic of an exemplary single tier actuator of the present invention labeled to show the sequence in which various components of the actuator interact with each other.

FIG. 13 is a schematic of an exemplary multi-tier actuator of the present invention labeled to show the sequence in which various components of the actuator interact with each other.

FIG. 14 is a schematic depicting an alternate sequence of component interactions of another exemplary multi-tier actuator.

FIG. 15 is a schematic of exemplary kinetic energy storage buffer system of the present invention.

FIG. 16a-b are a pair of tables defining the various action groups and component interaction of the KES buffer system of FIG. 15.

FIG. 17 is a schematic of an exemplary KES buffer system variant incorporating a Halbach array, permanent magnet alternator-generator, a Faraday cage.

FIGS. 18a-b are a pair of tables defining the various action groups and component interactions of the KES buffer system variant of FIG. 17.

FIG. 19 is a schematic depicting various topologies in which the actuators of the present invention may be arranged.

### DETAILED DESCRIPTION

The present invention comprises correlated magnet actuators, devices incorporating said actuators, and methods of use thereof. The actuators utilize magnetic drives comprising a pair of complimentary correlated permanent magnet pairs, arranged in a separable and opposing fashion. The attractive or repulsive force of each correlated magnet pair drops significantly after only a few degrees of rotation off of a prime attractive or repulsive rotational alignment, allowing the magnets to be binarily manipulated between a correlated and decorrelated alignment. The linear motion resulting from the periodic coupling and decoupling of the magnetic pair can be translated to supporting conveyance structures to produce rotary (torque) output work. This output work can be harnessed to drive secondary utilization components such as a generator or a pump, or other devices dependent on rotary work output for their operation.

### Correlated Magnets

A “correlated permanent magnet” as used herein, refers to a magnetic structure having multiple magnetic field sources on a single substrate, wherein the position and polarity of each magnetic field source is arranged on the substrate according to a desired pattern or code. The process of arranging magnetic field sources on a solid substrate is further described in U.S. Pat. No. 7,800,471, which is herein incorporated by reference. Exemplary correlated magnets include printed Coded Magnets™. The pattern or code defines one or more prime attraction and/or repulsion and/or field canceling orientations (i.e. magnetic states) between a pair of correlated magnets. The two complimentary correlated magnetic structures can achieve a peak attractive force when their complimentary magnetic field source pairs align. For any other translational or rotational alignment the force between the two complimentary correlated actuation magnets is substantially less than the peak force. As noted above, the spatial relationship between the two correlated magnet tiers may be positionally altered via the application of rotary or linear movement in order to cause a purposefully timed coupling (correlation) and uncoupling (decorrelation) of a tier's magnetic force.

The attractive or repulsive force of each correlated actuation magnet pair drops significantly after only a few degrees of rotation off of the prime attractive or repulsive rotational alignment. The relative gross torque determines the force that must be applied to rotate one correlated magnet relative to another in order to move the magnet off the prime attractive or repulsive position. The relative torque required to decorrelate may be significantly lower than the gross attractive or repulsive magnetic force of the correlated actuation magnet tier. The gross attractive or repulsive magnetic force of a correlated actuation magnet tier as divided by the gross torque required to decorrelate the correlated actuation magnet tier is defined herein as “magnetic leverage.” The ratio of the gross attractive or repulsive magnetic force of a correlated actuation magnet tier to gross decorrelation torque is defined herein as the magnetic leverage ratio (MLR). For example, if the gross attractive force or repulsive magnetic force of a correlated actuation magnetic tier is 18 pounds and the gross torque required to decorrelate the correlated actuation magnet tier is 1 inch pound, the MLR is 18. If the gross attractive or repelling magnetic force of a correlated actuation tier is 42.10 pounds and the gross torque required to decorrelate the correlated actuation magnet tier is 1.30625 inch pounds, the MLR is 32.22966.

Any suitable magnetic material may be used in the context of the present invention. The use of a particular magnetic material is limited by the dynamic durability of the magnetic material's magnet dipoles. The size of the magnetic material used is scalar and can vary over a wide range, limited only by the ability to manufacture suitable correlation and decorrelation mechanisms such as those described herein. Factors affecting magnetic material selection may include selection of materials that exhibit increased intrinsic coercivity, increased temperature stability, increased stability during dynamic operation, and maximum energy product. “Increased intrinsic coercivity,” as used herein, refers to a material's resistance to demagnetization and is equal to the demagnetizing force which reduces the intrinsic induction in the material to zero after magnetizing to saturation. In one exemplary embodiment, the magnetic material is a neodymium magnet.

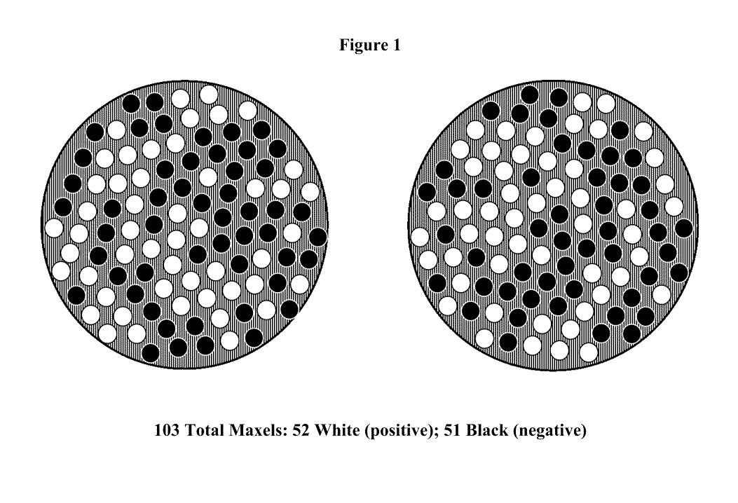

A wide range of coding patterns on the correlated magnet may be used with the present invention. An exemplary coding pattern is shown in FIG. 1. When selecting a coding pattern the following performance characteristics should be considered; patterns that creates the lowest residual separation force at the decorrelation point, patterns that results in the desired additive force and distance efficiency for magnets, patterns that results in the lowest degree of rotation required to reach the decorrelation position, and a pattern that provides the lowest rotary release torque to enact decorrelation.

### Correlated Magnetic Drives

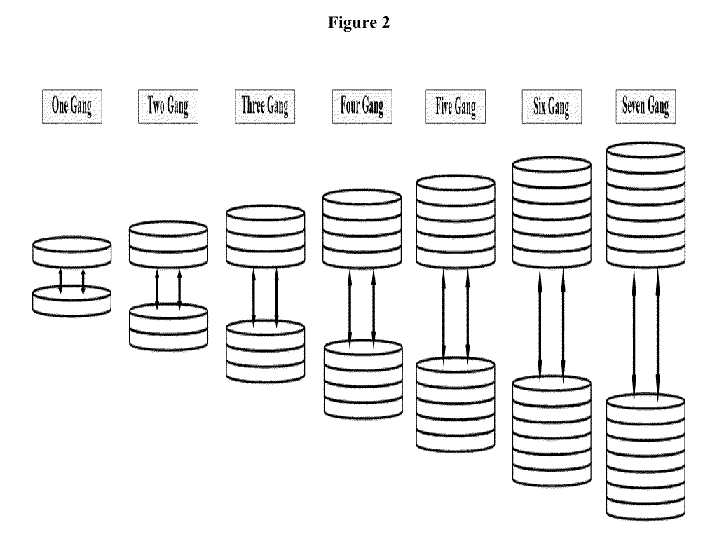

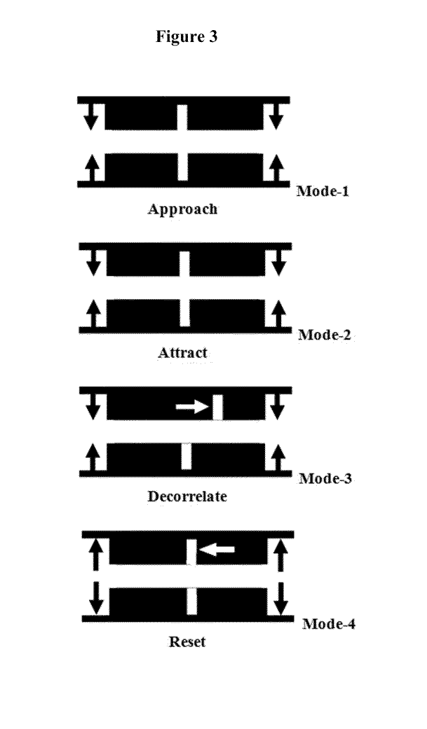

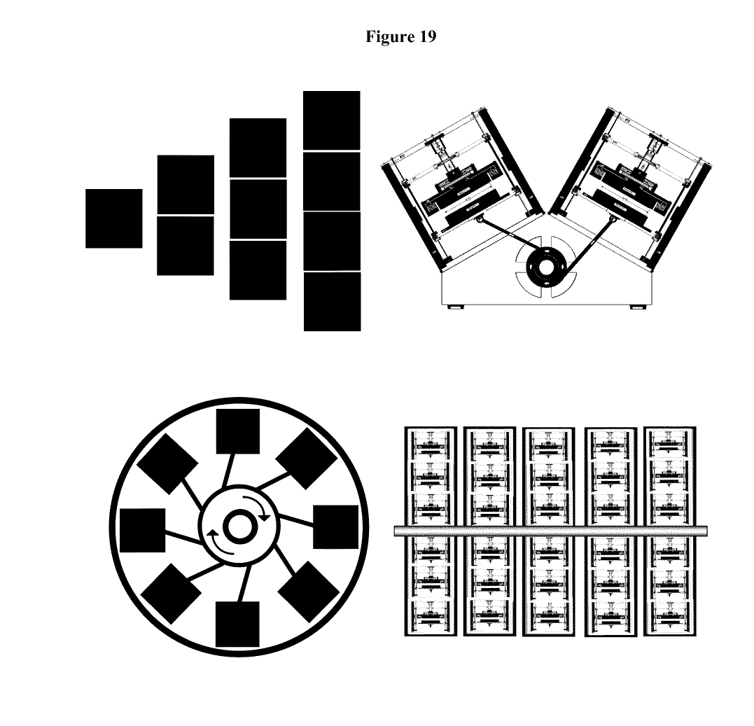

A correlated magnetic drive comprises a tier-pair. The tier-pairs may be arranged in an angled, horizontal, or vertical arrangement. Each tier may comprise a single correlated permanent magnet or series of correlated permanent magnets. Each magnet may be a monolithic magnet or a multi-geometric variant thereof. “Monolithic” as used herein refers to a single magnet volume as opposed to multi-geometric variants thereof, which may include laminated or stratified magnet topologies. As shown in FIG. 2, the magnetic force per magnetic drive may be altered by varying the gross magnetic volume of each tier. Each tier resides in a separate housing, or retainer, that allows each tier to be separately connected to supporting linear and rotational force conveyance structures. A correlated magnetic drive and any supporting conveyance structures form a single-tier actuator of the present invention. Multiple single-tier actuators may be coupled together to form multi-tier actuators. Multi-tier actuators may further be connected in series or parallel to form multi-tier actuator arrays. Multiple actuators may also be arranged in a number of additional topologies including, but not limited to, V-drive, radial, linear, opposing piston, W-drive, and X-drive. Exemplary actuator system topologies are show in FIG. 19. Also encompassed within the present invention are devices that incorporate the actuators of the present invention.

The actuators of the present invention mechanically convey correlated magnet tier-pairs of a magnetic drive sequentially and directionally through each of four periodic operating cycle modes. Interconnected conveyance structures enable fulfillment of the four periodic operating cycle modes, which are comprised of a series of discrete travel distances and force directions, in a continuous fashion.

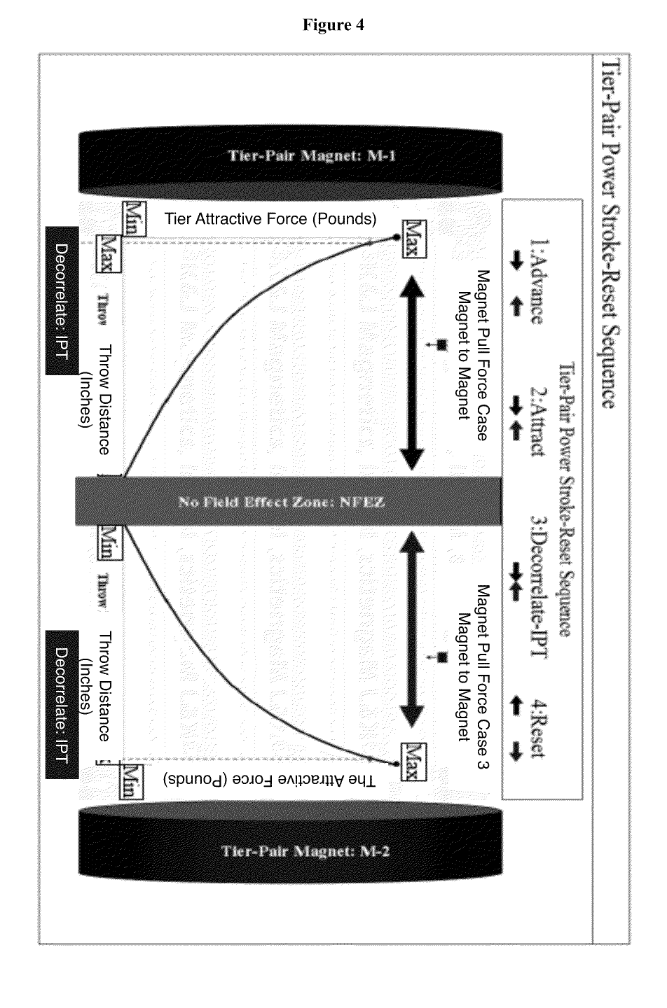

Referring to FIGS. 3 and 4, the first mode comprises the translation together of a previously fully separated magnetic drive tier-pair. The initial translation force may be derived from an initial actuation driver. The initial actuation driver may be electrical, pneumatic, hydraulic, kinetic, or a combination thereof. First mode positioning action culminates in the dynamic attraction of the second mode. The second mode is the forceful translation together of a tier-pair that occurs when the two magnetic field domains of that tier-pair are placed in sufficient proximity to cause dynamic engagement. The second mode (i.e. power stroke) is derived from the dynamic magnetic attraction and culminates in the tier-pair decorrelation of the third mode. The third mode is the sequential linear translation and subsequent rotation of one of two tier magnets (i.e. magnet 1 rotates “X” degrees with respect to magnet 2). Third mode translation may occur in certain embodiments from the forced engagement of two inclined plane translator gears (one fixed, one rotating) which yield decorrelative rotation when linearly driven together. Third mode translation force is derived from the final portion of the power stroke travel occurring in the second mode. Third mode decorrelative decoupling is the binary manipulation (turning off) of the magnetic attractive force between two correlated magnets comprising a magnet tier-pair and culminates in the translation apart of a previously fully attracted magnet tier-pair of the fourth mode. Fourth mode positioning action culminates in specified tier separation. Thus separated, a tier-pair is now positioned to re-initiate the first mode.

In certain exemplary embodiments, dynamic positioning of the actuator structural components and the rotary manipulation of the correlated magnet tiers is continued by a continuing actuation driver. Work supplied by the continuing actuation driver is utilized to continue timed motion and relative orientation of the actuator systems dynamic components and correlated magnet tiers. The continuing actuation driver may be electrical, pneumatic, hydraulic, kinetic or combination thereof.

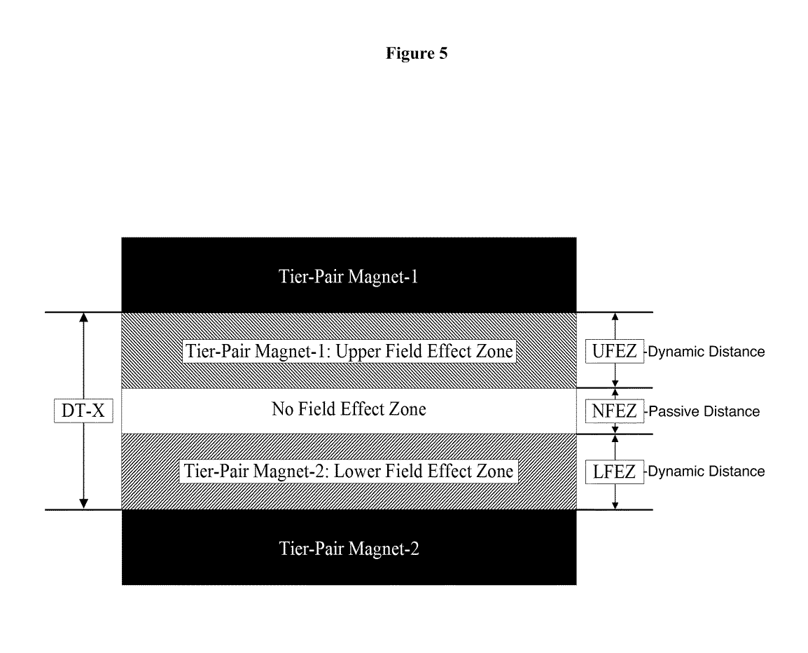

The properties, geometric design and required travel distances of the magnetic tiers utilized in the present invention may be calculated by determining the correlated magnet field effect zone limits (DT-X). As shown in FIG. 5, the DT-X comprises two elements; the no field effect zone (NFEZ) and the upper and lower field effect zones (UFEZ and LFEZ respectively). The NFEZ defines the distance required for tier-pair engagement. The UFEZ and LFEZ define the power stroke resulting from tier-pair engagement. The purpose of determining DT-X and its components UFEZ, LFEZ and NFEZ is to establish the limits and therefore force and distance translation metrics in order to precisely determine the physical design of the accompanying actuators\ mechanical structures. The following provides an exemplary framework for determining field zone effect zone limits. First, determine, via physical measurement, the magnetic field force limits of UFEZ and LFEZ for a tier-pair, which in turn establishes the distance boundary of the NFEZ for a tier-pair. Next, determine, via measurement, the total dynamic throw distance (TDTD=UFEZ+LFEZ) available from a tier pair. Then determine and combine the minimum distance of TDTD engagement required to begin magnetic translation and the minimum distance of NFEZ to ensure total magnetic disengagement between tier-pair magnets. The combined distance may then be utilized when designing a decorrelation mechanism to ensure the proper degree of rotation between correlated and uncorrelated alignment of the tier-pairs and when designing the supporting mechanical linkages to ensure a sufficient level of translation of tier-pairs towards and away from each other.

### Supporting Conveyance Structures

The supporting conveyance structures capture the magnetic force produced by the dynamic interaction of correlated magnet pair and translate it to useable linear and rotary work output. Supporting conveyance structures may comprise a fixed frame component, a variable frame component, and a common output shaft. The fixed frame component provides static connection points for the variable frame components. Exemplary fixed frame components include enjoined horizontal and vertical plates. In certain exemplary embodiments, the fixed frame components may further comprise a pair of connecting or guide rods extending internally and parallel over the length of the fixed frame. The variable frame components provide dynamic translation of magnetic force during operation of the actuator. In certain exemplary embodiments, the variable frame components may be considered to form part of the common output shaft. A common output shaft functions to translate magnetic force from a magnetic drive, and in certain embodiments, from opposing actuator translation as a common work output. In one exemplary embodiment, the variable frame components are connected to the fixed frame components via a saddle shaft that is attached to and moveable along a pair of fixed connecting rods. In certain exemplary embodiments, the first tier of the magnet drive is attached to a fixed frame component and the second tier is attached to a variable frame component.

To optimize the duration of dynamic system operation occurring after an initializing kinetic energy event, a conveyance structure should be designed to minimize inter-component friction and minimal component weight. Supporting conveyance actuator components are preferably constructed of a completely non-magnetically (CNM) reactive composition such as machined, injection molded or cast ceramics, composites, engineered plastics or alloys with a magnetic permeability of <1.001. Joining of actuator component may be accomplished with mechanical enjoinment, injection molding, ultrasonic welding, vibration welding, spin welding or other materially compatible methods of enjoinment. To minimize friction between moving parts, various thrust, linear and radial bearings may be used. Suitable bearings include passive correlated magnetic bearings, stainless steel ESA bearings, titanium alloy bearings, all-ceramic bearing (oxide-based bearings), and engineered plastic bearings. Exemplary engineered plastic bearings include, but are not limited, polyoxymethylene, acetal, Delrin™ (POM) or other similar semi-crystalline engineered polymers, including but not limited to polyethylene (PR), polypropylene (PP), polyamidenylon (PA), and polytetrafluoroethylene (PFTE).

### Decorrelation Drives

The actuators of the present invention may further utilize decorrelation drives. A decorrelation drive functions to decorrelate a correlated magnetic pair by providing the necessary torque to move a tier off of its peak, or strong, attractive alignment. Accordingly, the decorrelation drive can be any electrical, pneumatic, hydraulic, or kinetic drive, or combination thereof, capable of applying the necessary rotary torque to decouple the tier.

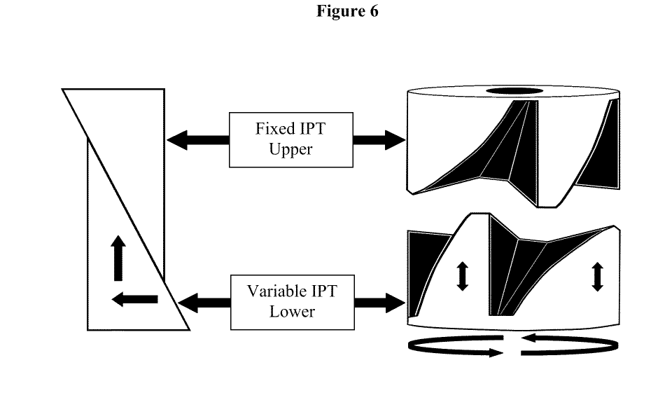

In certain exemplary embodiments, the decorrelation drive may utilize an inclined plane translator (IPT), or similar mechanism, to effectuate periodic coupling and decoupling of magnetic tiers. An IPT may comprise two incline plane gears, one fixed (static-upper) and one rotating (variable-lower). An exemplary IPT is shown in FIG. 6. The lower IPT may be connected to one tier of a magnetic drive and the upper IPT to a fixed component of the actuator. In certain exemplary embodiments, the IPT gears are configured so that linear motion caused by the coupling of two opposed correlated magnetic tiers results in the engagement of the lower IPT gear with the upper IPT gear. The linear force interaction between the two inclined planes results in rotation of the lower IPT a specified number of degrees, pursuant to the geometry of both inclined gear surfaces. The resulting rotational force is translated, via the lower IPT, to the coupled tier of the magnetic drive resulting in the rotary decoupling of the magnetic drive. Such interlinked tier coupling and/or uncoupling allows actuators of the present invention to sequentially convey magnetically leveraged force from tier to tier. Engagement of all tiers then allows the multilevel actuator of the present invention to wholly impress the gross repulsive or attractive magnetic force output of all the tiers into work output.

An exemplary decorrelation drive may comprise a nesting spline shaft segment, an IPT, and a recorrelation delay mechanism (RDM), wherein a lower IPT gear is coupled to a top portion of the nesting spline shaft segment and an upper IPT gear is attached to the RDM. The lower section of the nesting spline shaft segment is coupled to a first tier of a magnetic drive. The nesting spline segment may further connect to a variable component of the actuator conveyance structure in a way that maintains the rotational freedom of the nesting spline shaft, for example, via a rotary flange. The decorrelation drive functions to first linearly translate or extend the reach of the power stroke of a magnet drive, via telescopic extension, and to translate subsequent IPT rotation to the correlated magnet of the first tier to decouple the magnet drive. In certain exemplary embodiments, the lower IPT gear may contain a guide key on its outer circumference designed to interact with a series of keyways defined on the inner surface of the RDM. The RDM functions to delay the recorrelation of a magnet drive, thereby assuring precise residual separation force of a magnet drive over a specified time. In certain embodiments, premature recorrelation can, if not delayed, produce a deleterious counter force to a magnet drive's gross attractive power stroke.

In another exemplary embodiment, IPTs are used to directly couple multiple magnetic drives together. For example, the first tier of each correlated magnet drive is coupled to a fixed element of an actuator frame and the second tier is coupled to a variable element of the actuator frame. A fixed incline gear is coupled to the second tier and a variable gear is coupled to the first tier of an adjoining magnetic drive. The coupling of the first tier results in the engagement of the IPT gears. The resulting IPT rotation is translated to adjoining tiers, resulting in their coupling and or decoupling.

### Drive Management Systems

The actuators of the present invention may further comprise a drive management system. The drive management system allows for controlled initiation and stop of magnetic drive function by engaging and preventing the rotation of the tier or tiers between their correlated and decorrelated positions. Any suitable start/stop mechanism for controlling rotary function may be utilized. An exemplary drive management system comprises a decorrelation start-stop (DSS) mechanism and a decorrelation return spring. The DSS provides start and stop functions for the actuator by restricting or allowing rotary return of the magnetic drives to a correlated position. The decorrelation return spring can cause magnetic drive and decorrelation drive return rotation to occur, pursuant to the return spring's torsion being repetitively applied to those operating drives.

### Kinetic Energy Storage Buffer Systems

The actuators of the present invention further comprise a kinetic energy storage (KES) flywheel, or buffer system. The KES buffer is a device of vertical or horizontal orientation, whose purpose is to provide utilization load isolation (i.e. buffering) for all actuator system iterations and to store for subsequent release, kinetic energy introduced initially by an initial actuation drive and in dynamic operation by the actuators themselves. The KES buffer system may be attached along a common output shaft between the actuators and a secondary utilization device. The physics and proportions of actuator components are dictated by the physical operating requirements of the secondary utilization device's loading profile. In order for the actuator system's common output to efficiently service the secondary utilization device's steady-state load operating requirements, actuator system component physics are based on a secondary utilization device's “worst case utilization loading scenario.” A primary goal of the actuator system sizing process is to ensure that all integrated components efficiently facilitate steady-state operation of the secondary utilization device over a defined loading profile, regardless of required proportions. In certain exemplary embodiments, the kinetic storage capacity of the KES flywheel is purposefully over-sized, in order to service a given secondary utilization device' “worst case load scenario” in adherence with a pre-specified steady-state load servicing variance (i.e. +/−1%). In another exemplary embodiment, the common work output of the actuator system is also purposefully oversized so that the actuator system introduces work into the KES flywheel at a rate exceeding the quantity of extracted utilization work. The amount of provisioning excess needed is determined by the rate of input work required to ensure steady-state operation of a given secondary utilization device within the confines of a pre-specified steady-state load servicing variance (i.e. +/−1%). When energy is extracted from the kinetic storage system during utilization, the flywheel's rotational speed is reduced as a consequence of the principle of conservation of energy; adding utilization excess work to the system during the dynamic drive phase, correspondingly results in maintenance of the design speed of the flywheel. “Utilization excess work” is defined herein as a quantity of dynamic drive input positive work provided in excess of the quantity of utilization negative work required.

In certain exemplary embodiments, alevitating axial magnetic bearing mechanism may be further coupled to the KES flywheel. An exemplary leviating axial magnetic bearing mechansim that may be attached to the KES flywhill is a Halbach array. The Halbach array may be a passive contact or actively controlled free correlated or non-correlated magnetic bearing system composed of two planar Halbach axial arrays and/or electrodynamic coils utilized in conjunction with radially stabilizing passive permanent magnet bearings. For axial stabilization at static state or low speed mechanical touch bearings may be provided. When the rotary design speed is achieved, flywheel levitation is achieved. Upon reaching the design speed the flywheel freely spins about its principal axis of inertia. In one embodiment the bearing system is entirely passive utilizing no electronics and no active feedback. In other embodiments the bearing system is utilizes electronics and active feedback stability correction.

In certain other exemplary embodiments, the actuators of the present invention further comprise a permanent magnet alternator or generator (PMA-G) mounted on the common output shaft whose purpose is to provide actuator and/or utilization system support via modest levels of self-generated electrical power. Variants of the PMA-G may furnish AC or DC power output for, but not limited to, system component control, utilization system control-communication, pilot excitation and other functions.

Turning now to the drawings, in which like numerals indicate like (but not necessarily identical) elements throughout the figures, exemplary embodiments are described in detail.

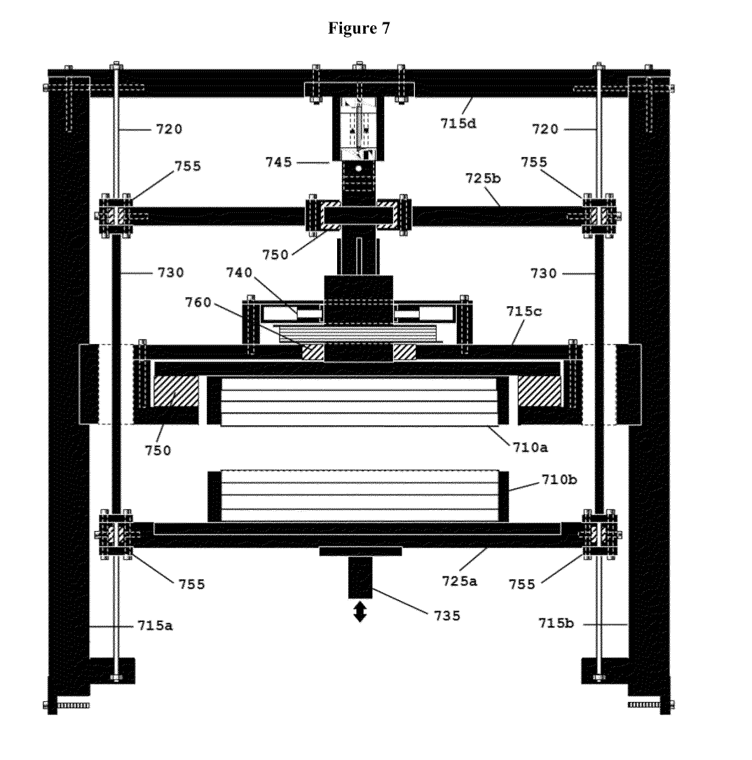

FIG. 7 depicts an exemplary embodiment of a single tier actuator 700. The actuator comprises a correlated magnet tier 710a and second correlated magnet tier 710b. The first correlated magnet tier 710a is connected to a fixed frame horizontal member 715c. A set of connecting rods 720 are attached to the inside of the fixed frame. The second correlated magnet tier 710b is connected to a variable frame horizontal component 725a. A second variable frame horizontal component 725b connects via a rotary flange to a decorrelation drive 745. The horizontal variable frame components 725 connect with the connecting rods 720 via a pair of saddle shafts 730. The horizontal variable frame members 725 and saddle shafts 730 form the variable frame component of the actuator which is further connected to a common output shaft component 735. A drive management system 740 is mounted on top of the first tier 710a of the magnetic drive and interacts with both the magnetic drive 710a and the decorrelation drive 745. Thrust bearings 750 may be utilized between the first correlated magnet tier 710a and the fixed frame horizontal member 715c, and between the rotary flange of the decorrelation drive 745 and the second variable frame horizontal member 725b. Linear bearings 755 may be employed at the joining of the variable horizontal members 725a and 725b with the saddle shaft and connecting rods 720. Radial bearings 760 may be utilized between the upper tier housing 710a and drive management system 730.

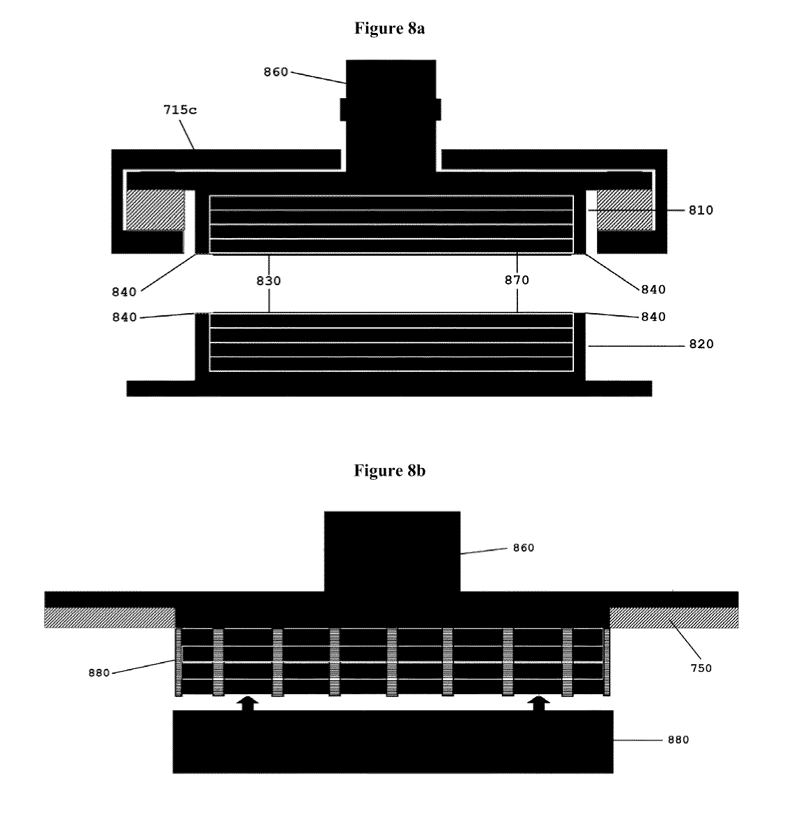

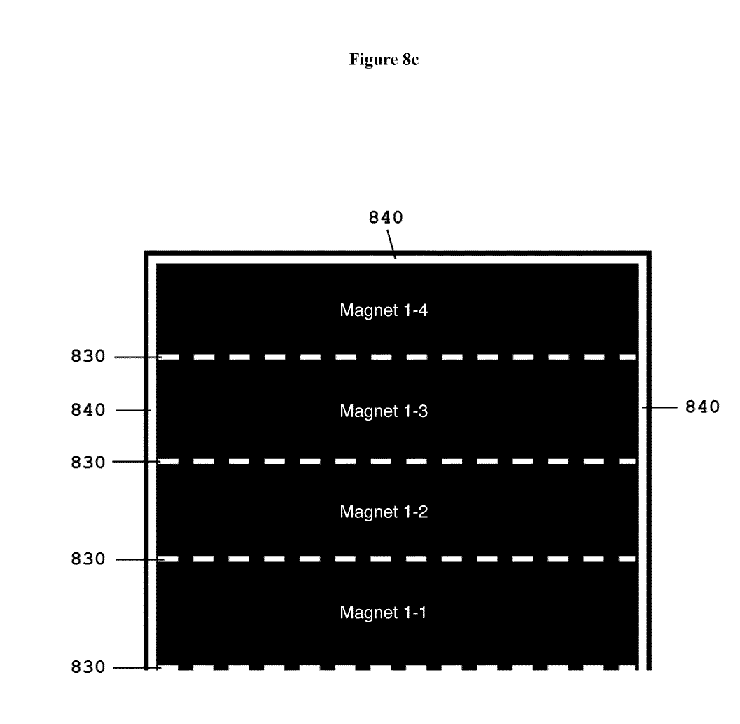

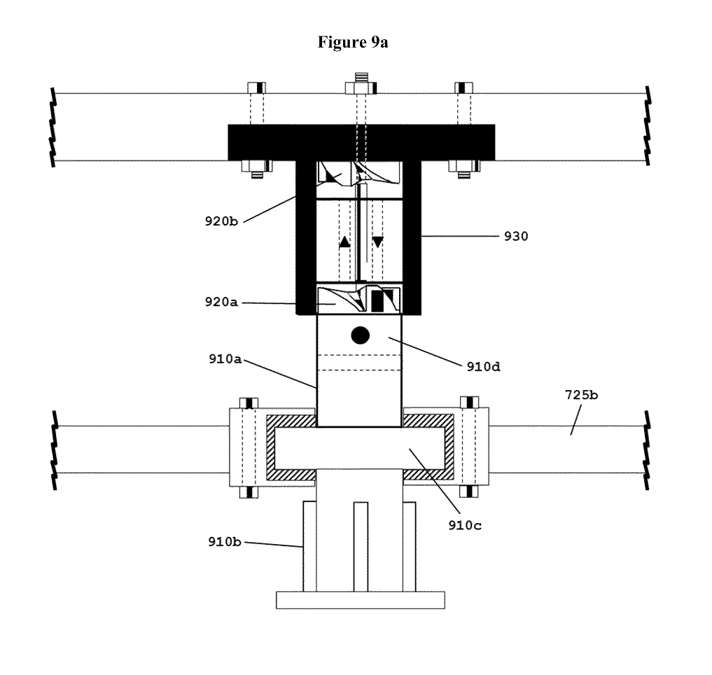

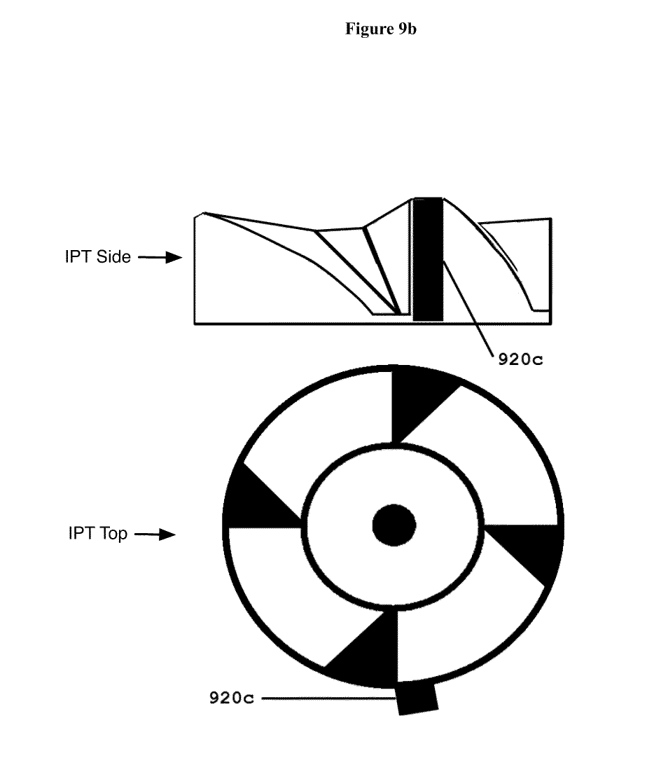

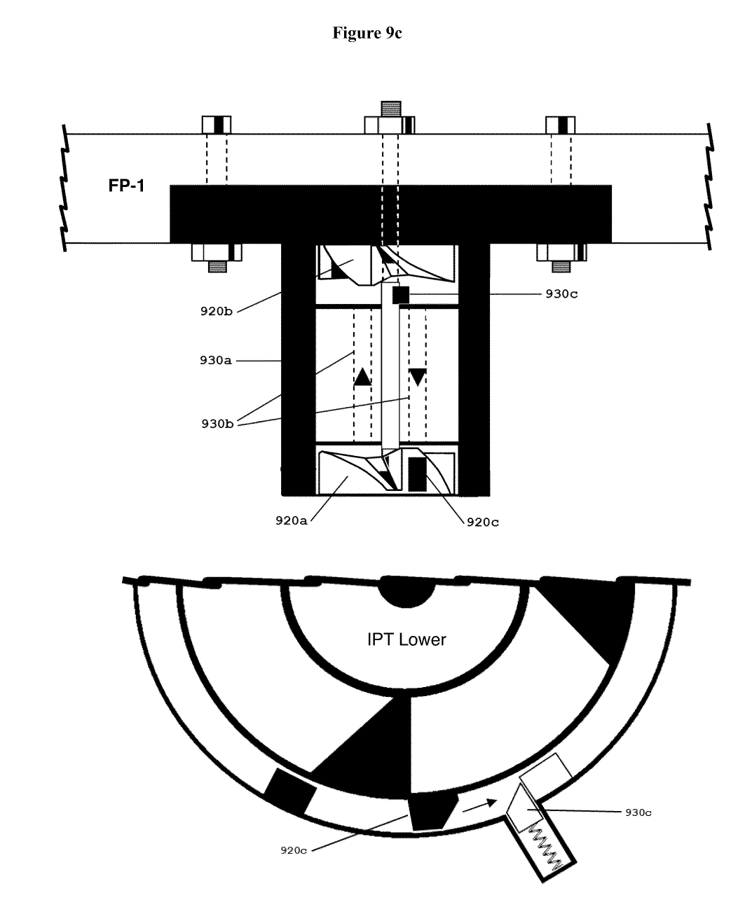

FIGS. 8a, 8b, and 8c provide a more detailed view of an exemplary magnetic drive of the present invention. The drive comprises a first magnet tier 810 and second magnet tier 820, each tier comprising a single complimentary monolithic correlated magnet, or multi-geometric variant thereof, or a series of complimentary correlated magnets that provide dynamic magnetic force, and correlation and decorrelation functions when spatially manipulated in relation to each other. An optional dielectric thin film 830 may be applied to the upper and lower surface of each magnet to separate the magnets from intra and inter magnet contact. An exemplary positioning of the dielectric thin film 830 to a nested magnet group is depicted in FIG. 8c. The magnet tiers sit in corresponding housings 840 or retainer cups. The housings 840 function as a retention component that firmly retains the magnet tiers during dynamic operation. The housing comprises an interior space that should be of sufficient restrictive geometry to retain the magnet tier. As show in FIG. 8b, the housings 840 may further comprise a threaded outer diameter 890, with notches cut vertically around the circumference of the cup. The purpose of the notch incisions is to cause compressive inward movement of the circumference of the cup pursuant to screw-on application or a compression retention ring 880. Returning to FIG. 8a, the housings further contain rotary translation flanges 850 which allows housing rotation by riding on a thrust bearing 750. The upper housing 840a further comprises a nesting spline shaft segment 860 for receiving a corresponding nesting spline shaft segment of a decorrelation drive described in further detail infra in reference to FIG. 9. In certain exemplary embodiments, the nesting spline shaft segment 860 contains a set of internal grooves for mating with a set of external keys on the corresponding nesting spline shaft segment of the decorrelation drive. The magnetic drive may optionally further comprise a removable adhesive gasket 870 applied around the outer circumference of the first magnet tier 810 and the inner circumference of the dielectric thin film 830. The removable adhesive gasket 870 provides further compression and adhesion of the first magnet tier 810 during dynamic operation of the actuator.

A critical tolerance for the actuator is the relative proximity of the two tier working faces of the magnets in each tier-pair (Magnet-1 face: first tier and Magnet-2 face: second tier) realized during dynamic operation. When the two tier magnets are attracted together during dynamic operation, the two tier magnets must achieve a relative proximity to each other that is as close as possible. Fit of the mated magnet retainer cup threaded stays and the compression ring should allow the relative proximity of the two tier magnet working faces to be as close as possible, and when mated should exert sufficient compressive radial force on the outer diameter threaded housing stays so as to hold tier magnets firmly in place during operation. The exertion of the compressive radial force occurs when the compression ring with threaded inner diameter is threaded onto the like threaded retainer forcing the stays to exert compressive force equally around the circumference of the tier magnets, thus firmly retaining the tier magnets. In addition to mechanical magnet retention force exerted by the compression ring and cup retainer, the optional removable adhesive gasket may be installed around the circumference of the first or both tier magnets to provide redundant positional stability. The importance of positional stability is directly related to precise maxel alignment between magnet tier elements.

FIGS. 9a-c provides a more detailed view of an exemplary decorrelation drive. The decorrelation drive comprises a nesting spline shaft segment 910, an IPT 920, and a recorrelation delay mechanism (RDM) 930. The nesting spline shaft segment 910 may further be defined by four machined regions denoted 910a-d. The nesting spline segment comprises a spline shaft 910a which functions to interconnect the decorrelation drive with the nesting shaft segment 860 of a magnet drive and translate linear and rotary force motion between the two. The nesting spline segment may further include a set of external spline shaft keys 910b, which function to couple rotation (correlation-decorrelation) by translating IPT rotation from the decorrelation drive to the magnetic drive, as well as enable retention-return force and start-stop control from an exemplary drive management system described in further detail infra. The nesting spline shaft segment may further include a rotary translation flange 910c, which enable decorrelation and magnetic drive rotation by riding on a thrust bearing 750. The nesting spline shaft segment may further comprise a retention recess 910d that provides an integrated and structurally stable mounting position for a lower IPT gear component.

As noted in FIG. 6 an IPT may comprise a lower variable IPT gear component and an upper static IPT gear component. In the present exemplary embodiment, the lower IPT gear component 920a is coupled to nesting spline shaft segment 910a via the retention recess 910d. The upper IPT gear component 920b is attached to the RDM 930, which is attached to a fixed component of the actuator. In certain exemplary embodiments the lower IPT gear may further comprise an IPT guide key 920c as show in FIG. 9b.

FIG. 9c provides a more detailed view of an exemplary RDM 930. The RDM comprises a housing 930a attached to fixed component of the actuator. The housing is machined to define a set of keyway paths 930b and contains a spring gate 930c as show in panel 2 of FIG. 9c.

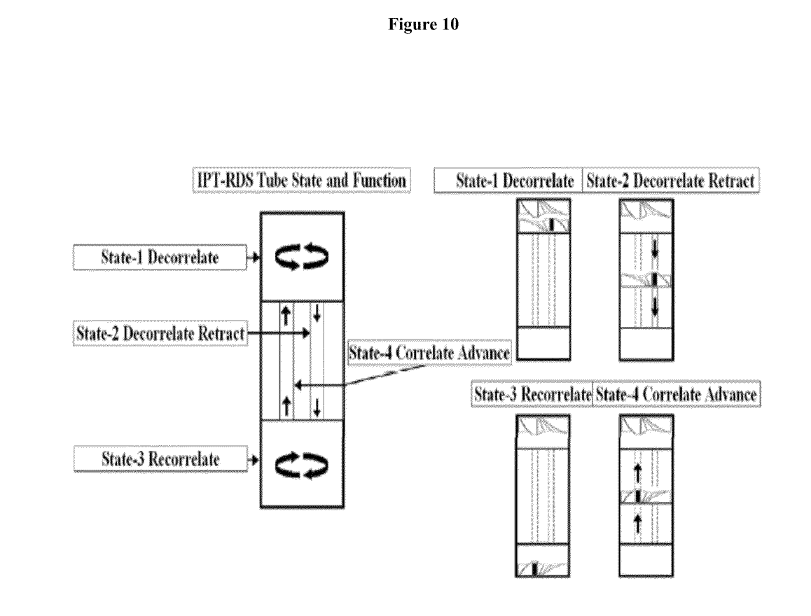

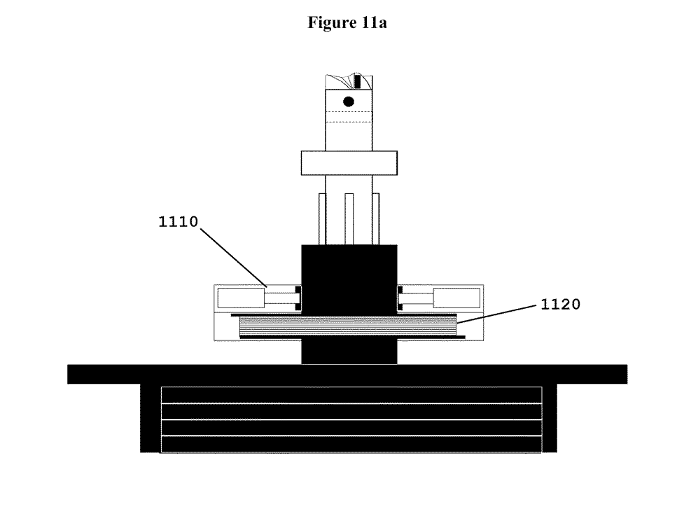

There are four function states comprising RDM action. An overview of the action states is provided in FIG. 10. In the first state (decorrelation), the power stroke of a magnetically attracting tier drives the lower variable IPT into the upper static IPT, thereby causing rotation and decorrelation of that tier. During the first state the RDM chamber does not restrict rotation of the variable IPT key. In the second state (decorrelated retraction), enactment of the first state causes the variable IPT to translate to a position of decorrelation. When the IPT guide key is rotated by IPT decorrelation action, the IPT guide key is translated laterally during rotation to impact and then depress the spring loaded gate key 930c. The IPT guide key passes the spring gate thereby becoming captive, without the potential of return in the decorrelation retract keyway. When the IPT key departs the return restriction of the second state keyway, the IPT key continues into the lower rotation chamber where third state (recorrelation) rotation occurs. When the variable IPT key enters the third state rotation chamber, unrestricted IPT return rotation occurs, the return rotation thereby resulting in the recorrelation of that tier. During the third state, the RDS chamber does not restrict rotation of the variable IPT key. Upon reaching the recorrelated position of the third state, the IPT key is now vertically conveyed (advanced) up the fourth state keyway. During fourth state motion the RDM keyway translates the variable IPT key towards the first state.

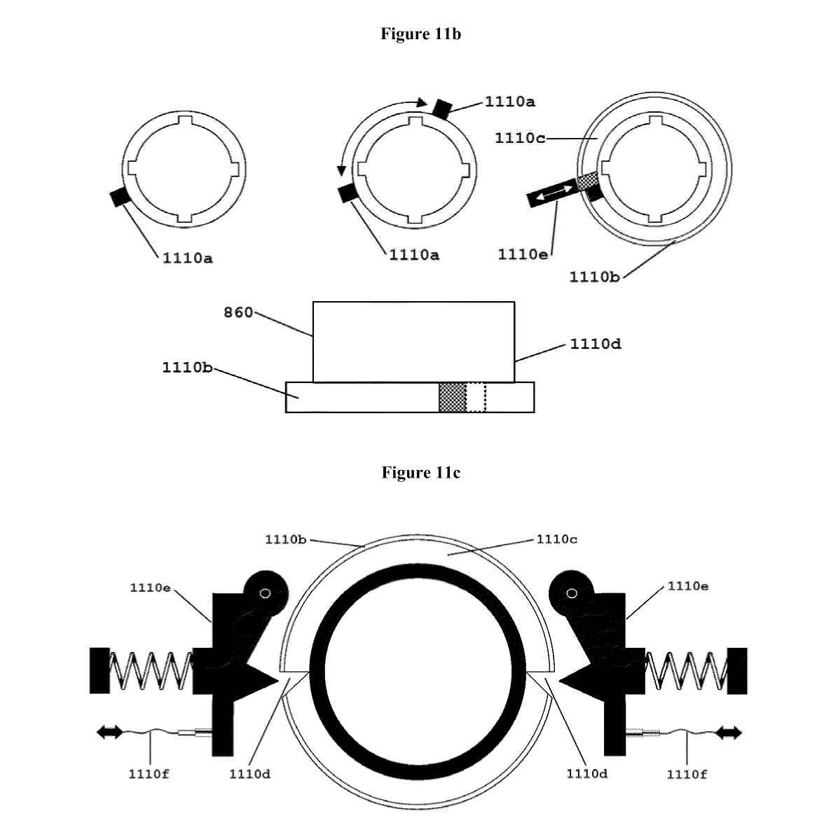

FIG. 11a-c depicts an exemplary drive management system (DMS) of the present invention. The DMS may comprise a decorrelation start-stop mechanism (DSS) 1110 and a decorrelation return spring 1120. The DSS system manages start and stop functions for the actuator by restricting or allowing rotary return of the magnetic drives to a correlated position. The DSS system is comprised of a series of machined surfaces formed longitudinally around the circumference of nesting spline shaft segment 850 of an upper tier housing of a magnetic drive. As shown in FIG. 11b, the machined surfaces are comprised of an integral retention key 1110a, a keyway shoulder 1110b, a keyway 1110c and purposefully placed keyway notches 1110d located in the keyway shoulder 1110b. The purpose of the keyway notch is to restrict further forward movement of a spring loaded stop block key 1110e or series of stop block keys upon realization of mutual component alignment.

The integral retention key 1110a may be machined onto the spline shaft segment 860. The spline shaft segment connects drive components, translates rotary force-motion system control as well as provides attachment interface points for the other DMS components. The keyway shoulder 1110b is a standoff surface formed longitudinally around the circumference of a nesting spline shaft segment 860. Upon release of a stop block key 1110e, the key rides on the surface of the keyway shoulder 1110b. The keyway shoulder 1110b provides a stop block riding surface. The riding surface shoulder is used as a secondary timing release mechanism, pursuant to the manual operation of a decorrelation start-stop cable 1110f. Upon initial control cable release the stop block key 1110e is forced by spring tension to ride along the keyway shoulder 1110b. Upon traversing the specified longitudinal distance around the circumference of the nesting spline shaft segment 860, the stop block key 1110e reaches an alignment position with the stop block keyway timing notch 1110d, and is forced by spring tension to enter the timing notch, thereby impeding further rotary reciprocation return from occurring and thereby ceasing dynamic operation of the actuator.

The stop block timing notch 1110d is a machined opening in an otherwise monolithic keyway shoulder placed around the circumference of nesting spline shaft segment 860. Upon manual latched release of the stop block key 1110e, the stop block is propelled partially forward by spring tension. Pursuant to that spring tension, the stop block 1110e presses on the outer (non-notched) portion of the keyway shoulder 1110b. The keyway shoulder thereby restricting further forward movement of the decorrelation key until the stop block aligns with and enters the timing notch 1110d. Upon realizing alignment with the timing notch opening 1110d, the previously applied spring tension continues conveyance of the aligned stop block through the timing notch opening. The stop block, upon reaching such alignment, realizes full conveyance into the keyway travel notch 1110d. Pursuant to the resulting keyway obstruction, the stop block 1110e is impacted by and therefore restrains correlation return spring action of the rotating nesting spline shaft segment 860.

The maintained (restrained) position of P2, show in FIG. 11b is the decorrelation state for the actuator tier. Position P2, and therefore a decorrelated state for that tier, will be maintained until the manual latch release of the decorrelation start-stop cable 1110f is pulled back into the latched (retracted) position. Pursuant to that manual latched (retraction) the system, unrestrained, may then realize correlation return and further dynamic operation.

The decorrelation return spring 1120 mechanically causes magnetic drive 710 and decorrelation drive 745 return rotation to occur, pursuant to the return spring's constant torsion being repetitively applied or retarded by manual control to those operating drives. Manual control is enacted by the decorrelation start-stop cable 1110f. The spring may be a non-magnetically reactive wound torsion spring statically bound to both the magnetic drive housing 840 and the nested spline shaft segment 860. The spring may be designed to provide sufficient rotary spring torque to reorient the magnet drive to a correlated position when not restricted by the DSS 1110. Translation states of the decorrelation return spring 1120 are: State-1, dynamically reciprocating (correlated-decorrelated): repetitive radial compression-release; and State-2, mechanically retained (decorrelated): radially compressed. In State-1 the decorrelation return spring 1120 is unimpeded by the retracted stop block key which therefore does not impede spline shaft repetitive rotary reciprocation and therefore repeated return by the decorrelation return spring 1120. State-1 allows rotary reciprocation return to occur in order to reciprocate between correlated and decorrelated orientations, thereby enabling dynamic operation of the actuator. In State-2, the first magnet tier is retained so as to be held in the spatial and therefore magnetically decorrelated orientation (M-1 w.r.t. M-2). State-2 mechanically retards rotary reciprocation return from occurring in order to maintain decorrelation and therefore cease further dynamic operation of the actuator.

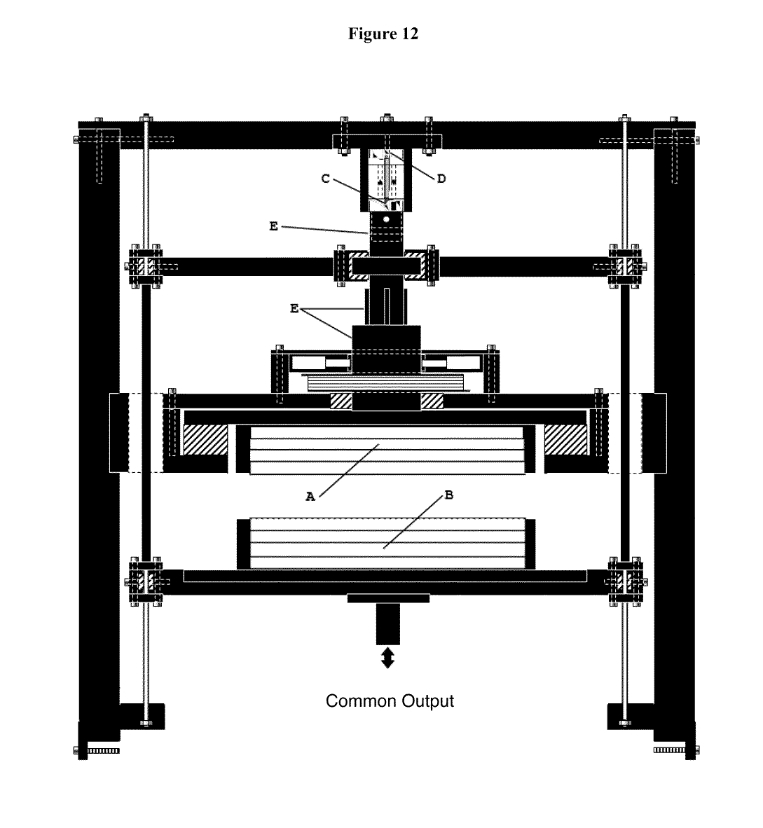

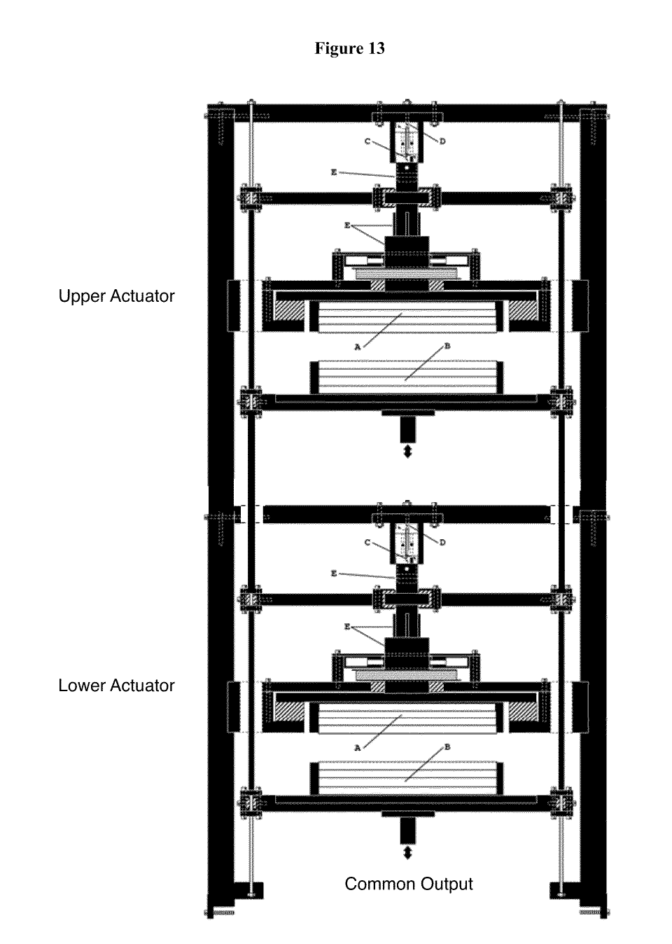

Operation of a single tier actuator as depicted in FIG. 7 is further described in reference to FIG. 12. An initial actuation device commences passive system rotation which in turn results via timing controlled release into dynamic magnetic attraction. Correlated magnet tier (A) is coupled to the rotating correlated magnet tier (B) of the magnetic drive by its proximity, and can lift and turn, via magnetic attractive force, the rotating correlated magnet in order to couple and de-couple the rotating correlated magnet with its corresponding fixed correlated magnet. Correlation of (A) and (B), results in attraction over a specified distance. The specified distance is dictated by the orientation and coding design of the correlated magnets. A variable incline gear (C) of the IPT then is translated in a upward linear direction, dictated by the action of (A) and/or the exertion of force on an incline plane by the fixed incline gear (D) of the IPT. The fixed incline gear (D) then causes rotation of the variable incline gear (C) via force on the inclined plane. The rotation of (C) turns a correlated magnet (B) of the tier a specified number of degrees, and whose rotation occurs due to the interconnection and rotary translation of the decorrelation drive (E), which couples or decouples with its corresponding fixed magnet. The corresponding fixed magnet then conveys the work output to a supporting structure, rods and interconnecting common output components. FIG. 13 depicts an exemplary multi-tier actuator. Operation of the multi-tier actuator proceeds the same as that of the single-tier actuator, except that the linear translation of one actuator can be coupled to the linear translation of an adjacent tier by coupling the magnetic drives of adjoining tiers to a common connecting rod.

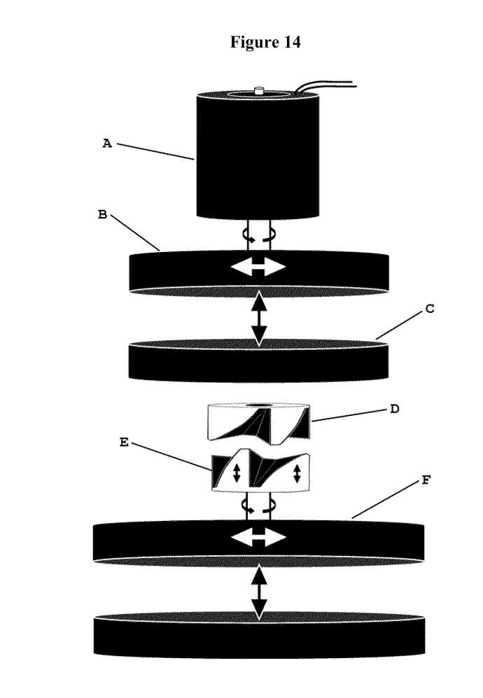

Operation of an exemplary embodiment of a multi-tier actuator where each is tier is directly coupled via and IPT is shown in FIG. 14. An initial actuation device (A) is coupled to a rotating correlated magnet (B) of a first tier, and can turn the rotating correlated magnet in order to couple and decouple the rotating correlated magnet with a corresponding fixed correlated magnet (C). Correlation of (B) and (C) results in linear attraction or repulsion of (C) over a specified distance. The specified distance is dictated by the orientation and coding of the rotating correlated magnet. A variable incline gear (E) of a first IPT then moves in a liner direction, dictated by the action of (C), to engage the fixed inclined gear (D). The fixed incline gear (D) then cause rotation of the variable incline gear (E) via force on the joined inclined planes. The rotation of (E) turns a correlated magnet (F) of the next tier a specified degree, which in turn couple or decouples (F) of the next tier a specified degree, which in turn couple or decouples (F) with its corresponding fixed magnet. The corresponding fixed magnet then convey the work output via a second IPT to the next tier in the sequence and/or conveys the work output to a common output shaft. An initial actuation device commences passive system rotation which in turn results, via timing controlled release, into dynamic magnetic attraction. Correlated magnet (A) is coupled to the rotating correlated magnet (B) in each tier by its proximity, and can lift and turn, via magnetic attractive force, the rotating correlated magnet in order to couple and de-couple the rotating correlated magnet with its corresponding fixed correlated magnet. Correlation of (A) and (B), results in attraction over a specified distance. The specified distance is dictated by the orientation and coding design of the correlated magnets.

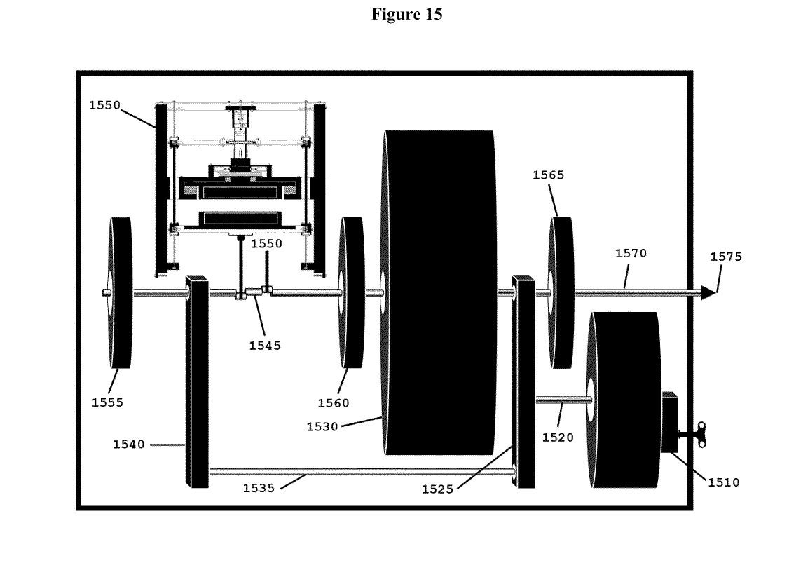

FIG. 15 depicts and exemplary kinetic energy system (KES) buffer embodiment. For purposes of illustration only, the exemplary embodiment is shown in conjunction with a V-drive actuator system kinetic variant. The KES buffer system of the present invention may be utilized with other topological variants comprises two or more actuators of the present invention as well as different initial actuation drivers. The KES buffer system comprises a manual charging interface 1510, a kinetic system starting spring 1515, a common system start drive shaft 1520, a kinetic start-actuator start transmission 1525, a KES buffer flywheel 1530, an actuator start drive shaft 1535, an actuator start transmission 1540, an actuation crank drive shaft 1545, a pair of correlated magnet actuators 1550, a transition flywheel 1555, an actuation isolation clutch 1560, a KES Buffer isolation clutch 1565, a common output drive shaft 1570, and a utilization system connection 1575.

The manual charging interface transmission 1510 may be a group of enclosed mechanically advantaged, transmission gears, whose purpose is to introduce kinetic energy into component the kinetic system starting spring 1515, by a manual winding action. The manual winding action being introduced by a key, hand crank or other means of kinetic energy introduction.

The kinetic system starting spring 1515 may be a concentrically wound kinetic energy storage spring, whose purpose is to store for subsequent release, kinetic energy introduced by component the manual charging interface transmission 1510. The kinetic energy stored supplies temporary initial actuation drive for the KES buffer flywheel 1530 and the correlated magnet actuators 1550.

The common system start drive shaft 1520 may comprise an interconnecting drive shaft that provides common system start (initial actuation drive) conveyance between the kinetic system starting spring 1515 and the kinetic start-actuator start transmission 1520.

The kinetic start-actuator start transmission 1525 may be a group of enclosed mechanically advantaged, transmission gears, whose purpose is to introduce common system start (initial actuation drive) kinetic energy into components KES Buffer flywheel 1530 and correlated magnet actuators 1550.

The KES buffer flywheel 1530 may comprise a kinetic energy storage device, of vertical or horizontal orientation, whose purpose is to provide utilization load isolation (buffering) for all actuation system iterations and to store for subsequent release, kinetic (rotational) energy introduced initially by the kinetic system starting spring 1515, during the initial actuation drive phase of operation and by the correlated magnet actuators 1050, during the continuing dynamic drive phase of operation.

The actuator start drive shaft 1535 may comprise an interconnecting drive shaft providing common system start (initial actuation drive) conveyance between the kinetic start-actuator start transmission 1520 and actuator start transmission 1540.

The actuator start transmission 1540 may comprise a group of enclosed mechanically advantaged, transmission gears, whose purpose is to introduce common system start (initial actuation drive) kinetic energy into the correlated magnet actuators 1550.

The actuation crank drive shaft 1545 may comprise an interconnecting drive shaft providing common system start (initial actuation drive), common system run (continuing actuation drive) and dynamic output conveyance between the correlated magnet actuators 1550, the mode-4-1 transition flywheel 1555, the actuator start transmission 1540, and the actuation isolation clutch 1560.

The mode-4-1 transition flywheel 1555 may comprise a flywheel mounted on actuation crank dive shaft 1545, whose purpose is to provide interim translational continuity between actuator operating cycle modes of Mode-4 (reset) and Mode-1 (approach), where Mode-4 is the translation apart of a previously fully attracted magnet tier. In the case of the V-drive topology variant, Mode-4 translation force being derived from an opposing actuator. Mode-4 positioning action culminates in specified tier separation. Thus separated, a tier is now positioned for Mode-1 Approach which is the translation together of a previously fully separated magnet tier.

The actuation isolation clutch 1560 may comprise a mechanical, centrifugal, magnetic or other clutch device whose purpose is to isolate the correlated magnet actuators 1550 from the KES Buffer flywheel 1530 until conflict-free dynamic action is appropriate between the aforementioned components.

The KES buffer isolation clutch 1565 may comprise a mechanical, centrifugal, magnetic or other clutch device whose purpose is to isolate the KES buffer flywheel 1530 from the common output shaft 1570 until conflict-free dynamic action is appropriate between the aforementioned components.

The common output shaft 1570 may comprise an inter-connecting drive shaft providing dynamic output conveyance between the KES buffer isolation clutch 1565 and a secondary utilization system.

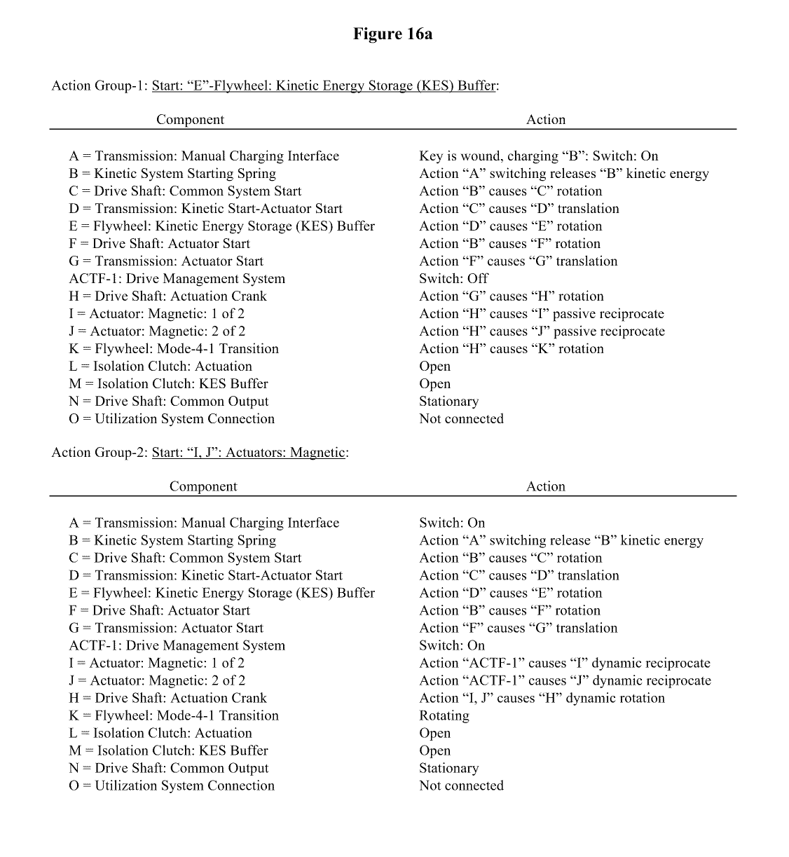

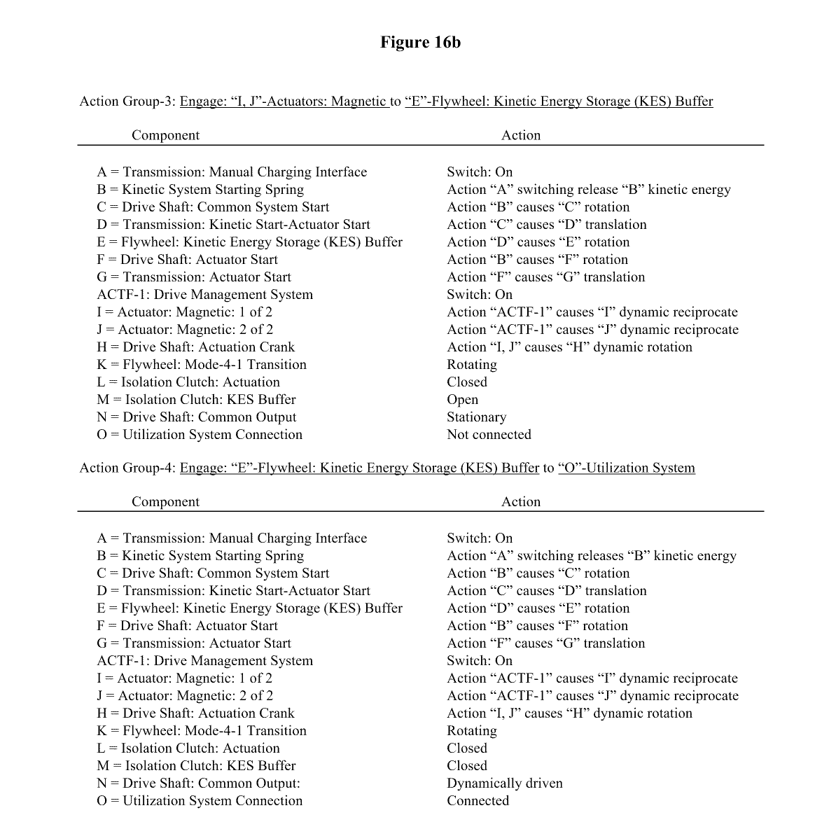

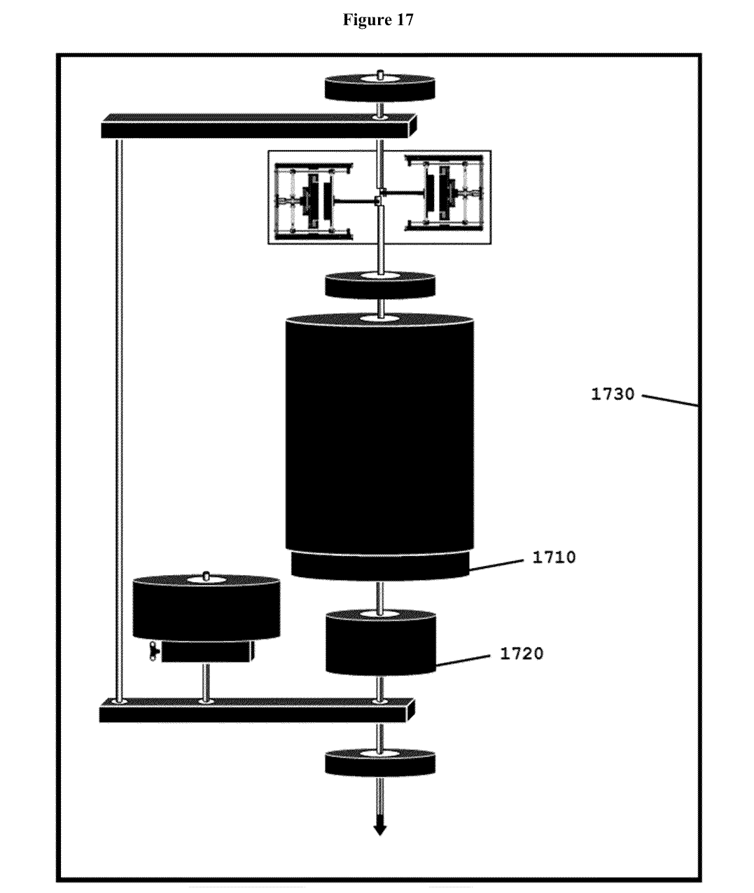

The sequential description of component actions can be broken down into four action groups. An exemplary detailed sequential description of component action by action group is show in FIGS. 16a and 16b.

FIG. 17 depicts an alternative embodiment of the KES buffer system further incorporating a Halbach array 1710 and a permanent magnet alternator-generator 1720. In certain exemplary embodiments the system may further be enclosed within a Faraday cage 1730. The Halbach array 1710 may comprise passive or active contact free correlated or non-correlated magnetic bearing system mounted in conjunction with the KES buffer flywheel 1530 and composed of two planar Halbach axial arrays and/or electrodynamic coils utilized in conjunction with radially stabilizing passive permanent magnet bearings. For axial stabilization at static state or low speed mechanical touch bearings are provided. When the rotary design speed is achieved, flywheel levitation is achieved. Upon reaching the design speed the flywheel freely spins about its principal axis of inertia. In one embodiment the bearing system is entirely passive, utilizing no electronics and no active feedback. In other embodiments the bearing system utilizes electronics and active feedback stability correction. The permanent magnet alternator-generator 1720 may comprise a permanent magnet alternator or generator (PMA-G) mounted on the common output shaft 1570, to provide prime mover and/or utilization system support via modest levels of self-generated electrical power. Variants of the PMA-G may furnish AC or DC power output for, but is not limited to, system component control, utilization system control-communication, pilot excitation and other functions.

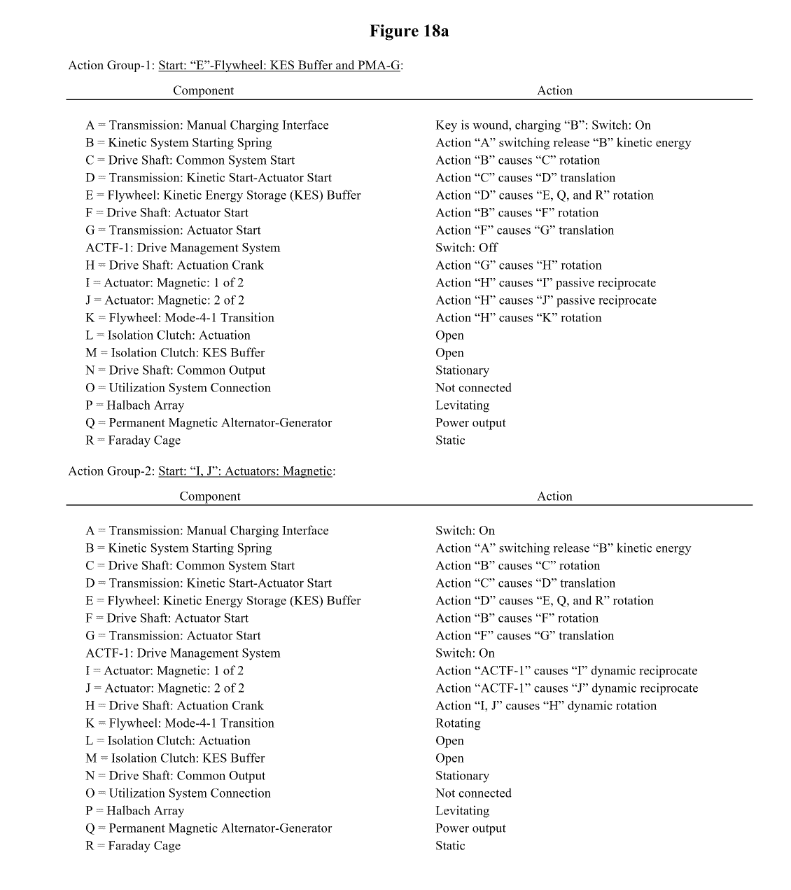

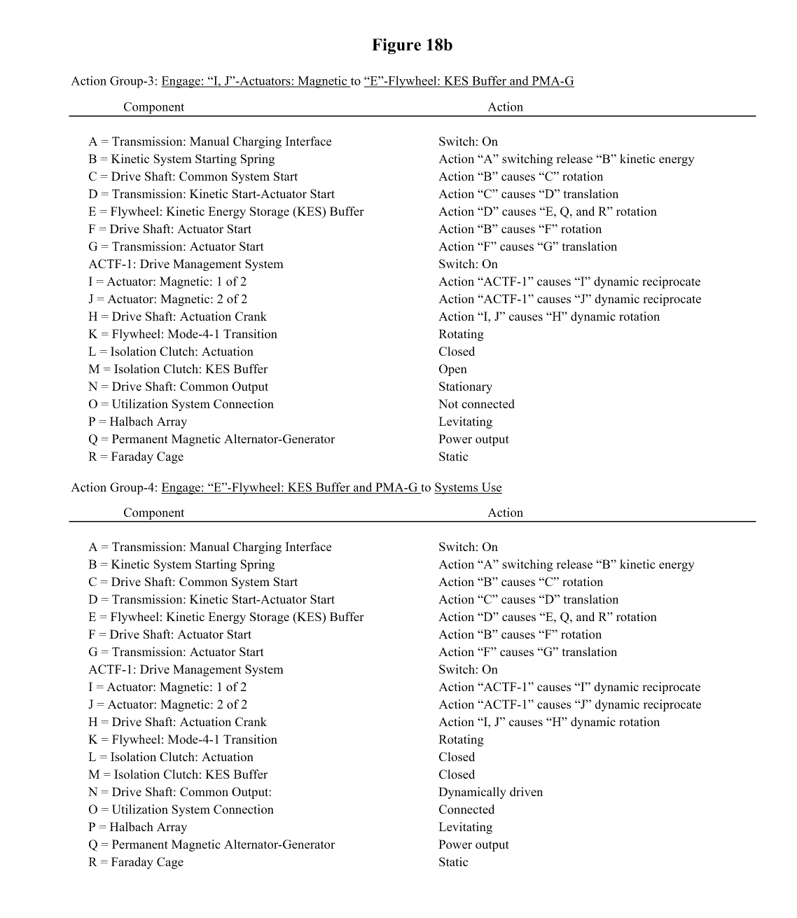

The sequential description of component actions in the Halbach array PMA-G variant can be broken down into four primary action groups. A detailed exemplary sequential description of component actions is provided in FIGS. 18a and 18b.

### Variant Topologies

The general actuator system designs described herein are readily adaptable to use with a number of secondary utilization systems. Table 1 provides an overview of various actuator system topology iterations and affected metrics that can be obtained by manipulating the various actuator system components.

TABLE 1

| | Affected Metric/ |
|---|---|
| Topology Iteration | Tradeoff |
| 1) Correlated Magnet Coding: | |
| a) Dynamic field effect zone | Translation distance |
| b) ″ | Common output work |
| c) ″ | System cycle rate |
| d) No field effect zone | Translation distance |
| e) ″ | System cycle rate |
| f) Peak attractive force | Common output work |
| g) Decorrelation torque | Common output work |
| h) Decorrelation rotation distance | Decorrelation time |
| i) ″ | System cycle rate |
| j) ″ | IPT geometry |
| k) Decorrelative residual separation force | Common output work |
| 2) Magnets: | |
| a) Maximum Energy Product (BH) max | Common output work |
| b) Intrinsic Coercivity (H_{ci}) | Dynamic durability |
| c) Volume (each) | Common output work |
| d) Quantity (multiplexed) | Common output work |
| e) Geometry | Thermal management |
| f) ″ | Common output work |
| g) Coatings | Thermal management |
| h) Dielectrics | Thermal management |
| 3) Actuators: Array: | |
| a) Volume (each actuator in array) | Common output work |
| b) Quantity (multiplexed actuators single array) | Common output work |
| c) Quantity (multiplexed arrays) | Common output work |
| 4) Inclined Plane Translator: | |
| a) Geometry | Common output work |
| b) Ratio gearing | Common output work |
| c) Ganged Magnetic Drives | Common output work |
| d) Magnetic IPT | Friction |
| e) CNM Material (Alloy) | Dynamic durability- |
| | weight |
| f) CNM Material (Engineered Plastic) | Dynamic durability- |
| | weight |
| 5) Actuator Common Output Shafts: | |
| a) ACOS-Saddle Shaft | (Baseline) |
| b) ACOS-Mono Shaft | Components: Decrease |
| c) ″ | Dimensions: Decrease |
| d) ″ | Force vector: Direct |
| e) ″ | Design simplicity: |
| | Increase |
| f) ″ | Weight: Decrease |
| g) ″ | Bearing count: Decrease |
| h) ″ | Friction: Decrease |
| i) ACOS-Multi Shaft | Components: Increase |
| j) ″ | Dimension: Increase |
| k) ″ | Force vector: Indirect |
| l) ″ | Design simplicity: |
| | Decrease |
| m) ″ | Weight: Increase |
| n) ″ | Bearing count: Increase |
| o) ″ | Friction: Increase |
| 6) Bearings: | |
| a) Completely Non-Magnetic (CNM) | Common output work |
| b) Passive Magnetic (Low RPM) | Common output work |
| c) Combined Thrust-Radial | Components: Decrease |
| d) Bi-Directional Thrust Bearing | Components: Decrease |
| 7) Materials: | |
| a) CNM Alloys | Dynamic durability- |
| | weight |
| b) ″ | Common output work |
| c) CNM Engineered Plastics-Resins | Dynamic durability- |
| | weight |
| d) ″ | Common output work |
| e) CNM Composites | Dynamic durability- |
| | weight |
| f) ″ | Common output work |
| 8) Production: | |
| a) CNM Alloys | Machining |
| b) ″ | High stress-ware |
| | components |
| c) CNM Engineered Plastics-Resins | Machining, Injection |
| | molding |
| d) ″ | Low weight-components |
| e) CNM Composites | Machining, Form |
| | molding |
| f) ″ | Low weight-components |

Although specific embodiments of the invention have been described above in detail, the description is merely for purposes of illustration. Various modifications of, and equivalent components corresponding to, the disclosed aspects of the exemplary embodiments described above can be made by those having ordinary skill in the art without departing from the spirit and scope of the invention defined in the following claims, the scope of which is to be accorded the broadest interpretation so as to encompass such modifications and equivalent structures.

What is claimed is:

1. An actuator comprising a correlated magnetic drive.

2. The actuator of claim 1, wherein the correlated magnetic drive comprises an upper magnet and lower magnet tier.

3. The actuator of claim 2, wherein each tier comprises a single correlated magnet or a series of correlated magnets, or a combination thereof.

4. The magnetic drive of claim 2, wherein the magnet or magnets comprising the upper and lower magnet tiers are monolithic or multi-geometric correlated magnets or a combination thereof.

5. The magnetic drive of claim 1, wherein the upper magnet retainer comprises a rotary translation flange defining an outer perimeter of an upper portion of the upper magnet retainer cup and an input spline segment extending vertically from the center of the upper magnet retainer cup.

6. The magnetic drive of claim 1, wherein the magnet or magnets are neodymium magnets.

7. The magnetic drive of claim 2, wherein each magnet is coated with a dielectric thin film on top and bottom surfaces of the magnet.

8. The magnetic drive of claim 2, further comprising an upper and lower threaded compression ring for insertion over the upper and lower magnet tiers respectively.

9. The magnetic drive of claim 8, further comprising a removable adhesive gasket applied about the circumference of the upper magnet tier.

10. An actuator comprising a correlated magnet drive, supporting conveyance structures, a decorrelation drive, and a common output shaft.

11. The actuator of claim 10, wherein the supporting conveyance structures comprise a fixed frame component, a variable frame component, and a common output shaft.

12. The actuator of claim 11, wherein the fixed frame component comprises a pair of fixed connecting rods extending internally over a length of the fixed frame component.

13. The actuator of claim 12, wherein the variable frame component comprises a pair of horizontal variable frame members attached to a pair of saddle shafts, wherein the saddle shafts are connected to the fixed connecting rods.

14. The actuator of claim 10, wherein the magnet drive comprises a separable top and bottom portion, wherein the top portion comprises a top correlated magnet tier housed in an upper magnet retainer and wherein the bottom portion comprises a lower magnet tier housed in a lower magnet retainer.

15. The actuator of claim 15, wherein the decorrelation drive is attached to a top portion of the fixed frame component and to the top portion of the magnet drive and is further moveably attached to a variable frame component, wherein the top portion of the magnet drive is further attached to fixed frame component, and the lower portion of the magnetic drive is attached to a variable frame component, and wherein the output shaft is coupled to the variable frame component.

16. The actuator of claim 10, wherein the decorrelation drive comprises a nesting spline shaft segment, an inclined plane translator and a decorrelation delay mechanism.

17. The actuator of claim 16, wherein the nesting spline segment comprises an upper shaft portion of a first diameter and a lower portion of a second diameter, wherein the upper and lower portion are separated by a rotary flange, and wherein the lower portion has a set of interior grooves that mate with a set of external keys on the upper portion.

18. The actuator of claim 16, wherein the incline plane translator comprises a separable fixed upper gear and variable lower gear, wherein the fixed upper gear is attached to a top portion of the decorrelation relay mechanism and the variable gear is attached to a top portion of the nesting spline segment.

19. The actuator of claim 18, wherein the lower variable gear further comprises and external guide key.

20. The actuator of claim 16, wherein the decorrelation delay mechanism comprises a housing defining a decorrelation retract keyway, a correlated advance keyway and a spring gate.

21. The actuator of claim 16, further comprising a drive management system.

22. The actuator of claim 21, wherein the drive management system comprises a decorrelation start/stop mechanism and a return spring attached to the bottom portion of the nesting spline segment.

23. The actuator of claim 10, further comprising an initial actuation device.

24. The actuator of claim 23, wherein the initial actuation device is an electrical, pneumatic, hydraulic, kinetic device, or a combination thereof.

25. The actuator of claim 23, wherein the initial actuation device is a charged mechanical main spring.

26. A device comprising the actuator of claim 10.

27. A device comprising two or more actuators of claim 10.

28. The device of claim 27, wherein the two or more actuators are arranged in a series or parallel configuration.

29. The device of claim 27, wherein the two or more actuators are arranged in a multiplexing array configuration.

30. The device of claim 27, wherein the two or more actuators are arranged in a V-drive, radial, linear, opposing piston, W-drive, or X-drive topology.

31. The device of claim 27, wherein the actuator or actuators are attached to a common output drive shaft (CODS) containing a kinetic energy buffer system.

32. The device of claim 31, wherein the kinetic energy buffer systems comprises a transition flywheel, an actuator start transmission, an initial actuation start transmission, an actuation isolation clutch, kinetic-energy storage (KES) buffer flywheel, and a KES buffer isolation clutch.

33. The device of claim 32, wherein the actuator start transmission and initial actuation start transmission are further connected directly to each other by a separate actuator start drive shaft, and wherein the initial actuation start transmission is connected to an initial actuation device by a common system start drive shaft.

34. The device of claim 32, wherein the transition flywheel is attached to one end of the CODS, the actuator start transmission is attached to the CODS adjacent the transition flywheel, the two or more actuators are attached to the CODS adjacent the actuator start transmission, the actuation isolation clutch is attached to the CODS adjacent the actuator(s) the KES buffer flywheel is attached to the CODS adjacent the actuation isolation clutch, the initial actuation start transmission is attached to the CODS adjacent the KES buffer flywheel, and the KES buffer isolation clutch is attached to the CODS adjacent the initial actuation start transmission.

35. The device of claim 33, wherein the initial actuation device comprises a manual charging interface attached to a kinetic system starting spring.

36. The device of claim 31 further comprising a Halbach array mounted to the KES buffer flywheel and a permanent magnet alternator mounted to the CODS adjacent the KES buffer flywheel.

37. The device of claim 34, wherein the device is enclosed in a Faraday cage.

38. A multi-tier actuator comprising two or more correlated magnet drives a variable frame, a fixed frame and an initial actuation device.

39. The actuator of claim 38, wherein the correlated magnet drives comprise a separable upper portion and a bottom portion, wherein the upper portion is connected to the fixed frame and the lower portion is connected to the variable frame.

40. The actuator of claim 39, wherein the upper portion of a first correlated magnet drive is attached to the initiation actuation device and a horizontal member of the fixed frame and the bottom portion of the first correlated magnet drive is attached to a horizontal member of the variable frame, and wherein each top portion and bottom portion of each additional adjacent magnet drive is attached to an adjacent horizontal member of the variable frame.

41. The actuator of claim 40, wherein a static gear of an incline plane translator is attached to a horizontal member of the fixed frame between the bottom portion of one adjacent magnet drive and the top portion of the next adjacent magnet drive, and wherein a corresponding variable gear of the incline plane translator is attached to the upper portion of the next adjacent magnet drive.
